(19) United States
(12) Patent Application Publication
(10) Pub. No.: US 2010/0125652 A1
(43) Pub. Date: May 20, 2010

(54) Method, Apparatus, and Computer Program for Binding Local Devices to User Accounts

(76) Inventors: Olli Rantapuska, Vantaa (FI); Petros Belimpasakis, Tampere (FI)

Correspondence Address: DITTHAVONG MORI & STEINER, P.C., 918 Prince Street, Alexandria, VA, 22314, US

(21) Appl. No.: 12/271,035

(22) Filed: Nov. 14, 2008

(51) Int. Cl. G06F 15/177

(52) U.S. Cl. 709/222

(57) ABSTRACT

Binding local devices to user accounts may involve receiving a registration message from a local device of a local network via an Internet connection. A public Internet identifier of the local network may be determined based on the Internet connection, and a user login to an account is received. The user login originates via the public Internet identifier of the local network. The local device is bound to the account based on the user login originating from the public Internet identifier of the local network.

### TECHNICAL FIELD

This specification relates in general to computer networking, and more particularly to a system, apparatus and method for binding local devices to user accounts.

### BACKGROUND

As devices become more and more powerful and ubiquitous, there is a move towards the service business. Network or online services allow people to manage their information online so that such information is always at hand no matter where the user is or what device they are using. These services may provide on-demand access to functions such as email, calendars, photo sharing, and the like. The services can be accessed from anywhere the user has an Internet connection, and by using whatever computing device that may be on hand.

Online services may be accessed using general purpose computing devices associated with personal computers, such as by browsers and other Internet clients. Increasingly, users have Internet capable mobile devices, and this may lead to an associated increased in the reliance on online services.

Other types of device that may be in strong demand are specialized home devices. For example, people may like to install sensors, security cameras and all sorts of entertainment devices in their homes. These home devices are sometimes user configured via a physical interface and/or by hooking the devices to computers, e.g., using a network, Universal Serial Bus (USB) connection, etc. In view of the specialized functionality of these devices and in order to minimize costs, the user interfaces of these devices may be limited. As a result, many users experience difficulty in using home devices to their full potential.

### SUMMARY

The present specification discloses a system, apparatus, computer program, and method for binding local network devices to user accounts. In one configuration, systems, apparatuses, computer programs, and methods receive a registration message from a local device of a local network via an Internet connection. A public Internet identifier of the local network is determined based on the Internet connection. A user login to an account is received. The local device is bound to the account based on the user login originating from the public Internet identifier of the local network.

In one variation, the local device may include a home device, and the local network may include a home network. In any of the above configurations, configuration of the local device may be facilitated via an Internet service associated with the user account. In such a case, facilitating configuration of the local device via the Internet service may involve embedding user interface controls for configuring the local device in a Web page associated with the user account.

In any of the above configurations, data may be received from the local device and added to the user account. In such a case, Internet access to the data of the local device may be facilitated in accordance with permissions of the user account. Also in any of the above configurations, the registration message may include a unique ID associated with the local device.

In any of the above configurations, a token may be sent to a user device from which the login was received in response to receiving the user login. In such a case, the token may be targeted for sending from the user device to the local device via the local network. Also in this case, the token may be received from the local device, and binding the local device to the account is further based on receiving the token.

In a second configuration, systems, apparatuses, computer programs, and methods facilitate a user login to an account via a local network. A token and a local address of the local device is received from the Internet service in response to the user login, and the token is sent to the local address to facilitate binding the local device to the account.

In one variation of this second configuration, binding the local device to the account may involve receiving data generated from the local device at the Internet service, and facilitating access to the data via the account. In any of the above second configurations, binding the local device to the account may involve facilitating configuring the local device via the Internet service, and further configuring the local device via the account.

In any of the above second configurations, the local device may be bound to the account based on the user login originating from a public Internet identifier of the local network. Also in any of the above second configurations, a browser pop up originating from the Internet service indicating a search for the local device is in progress may be presented in response to receiving the token and the local address of the local device from the Internet service.

### BRIEF DESCRIPTION OF THE DRAWINGS

The present specification is associated with the embodiments shown in the following diagrams:

FIG. 1 is a block diagram of a system according to example embodiments of the invention;

FIG. 2 is a sequence diagram illustrating binding a local device to a user account according to an example embodiment of the present invention;

FIG. 3 is a block diagram illustrating network service interface screens according to an example embodiment of the present invention;

FIG. 4 is a block diagram of a multiple network address translator system according to example embodiments of the invention;

FIG. 5 is a sequence diagram illustrating binding a local device behind multiple network address translators to a user account according to an example embodiment of the present invention;

FIG. 6 is a sequence diagram illustrating how binding of a local device to the wrong user account is prevented according to an example embodiment of the present invention;

FIG. 7 is a block diagram illustrating an example local device according to an example embodiment of the invention;

FIG. 8 is a block diagram illustrating an example computing structure suitable for providing services according to example embodiments of the present invention;

FIGS. 9-11 are flowcharts of procedures according to example embodiments of the invention; and

FIG. 12 is a sequence diagram illustrating binding a local service to a user account according to an example embodiment of the present invention.

### DETAILED DESCRIPTION

In the following description of various example embodiments, reference is made to the accompanying drawings that form a part hereof. It is to be understood that other embodiments may be utilized, as structural and operational changes may be made without departing from the scope of the invention.

Generally, the present description relates to configuring and using local network devices, such as home devices, seamlessly with online, e.g., Web, services. As will be described herein below, the local network devices may include, but are not limited to, special-purpose devices that may include minimal user interfaces. For example, devices such as sensors, cameras, controllers, appliances, etc., may have minimal and/or hard to access user interfaces.

Such home devices may be capable of generating data that is useful on a personalized network service. For example, a home security camera could upload its pictures to a user account of a Web service. As a result, managing home devices via an online service may be useful. For example, an online account may be easy to access, and the user interface may be better than a device's own user interface.

In such a case, it may be desirable to have a Web service bind accessory devices like a camera to a user account without user intervention. In such an event, a user associated with the account may be able to view any configuration user interfaces of the device when logging in to the user account. The user may further be able to see content produced by the device, e.g., photos, sensor readings, immediately when logging in. This specification proposes binding a device and user account together using a public network identifier, such as an external address of a Network Address Translation (NAT) gateway, firewall, router, etc.

A device using NAT may be referred to herein as a NAT firewall, or simply NAT. A NAT firewall connects a local network with an external network, e.g., Internet service provider network. A NAT generally creates and maintain mappings between Internet Protocol (IP) addresses and ports of the local network and addresses/ports of an external, public network. A NAT firewall may be the only device of the local network assigned with a public IP address, and all other devices of the local network have private IP addresses. The NAT may be setup as the default route on the local network, and will reassign Transmission Control Protocol (TCP) and User Datagram Protocol (UDP) ports on the external side of the connection when connecting to external hosts. On the internal side of the NAT, users may configure the local network to use non-Internet routable private IP addresses, e.g., 10.0.0.0/8, 192.168.0.0/16, as defined by the Internet Engineering Task Force (IETF). The use of private address spaces assures that there will be no conflict with public IP addresses when traffic needs to be routed outside the local network. The local network may be such as a wireless or wired local area network (LAN), residential local area network, home network, business network, company network, in-vehicle network, and/or the like.

When a networked local device connects to Internet services, it may be able to log in with its device type identifier but may not know anything about its user or owner. When the user or owner logs in to Internet services, the list of networked local devices he owns may not be known to the service. In various embodiments shown below, the external NAT IP address may be used to bind the user account and devices together. When the user and devices connect to Internet services, the connections originate from the same public IP address so the service may perform this binding without user intervention. The user can then “adopt” the device via an account associated with the online service.

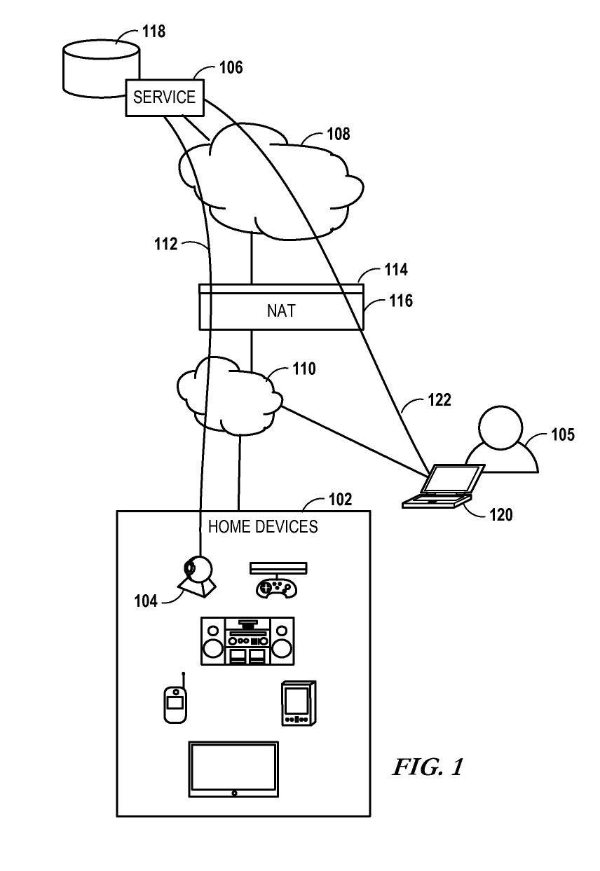

In reference now to FIG. 1, a block diagram illustrates how a local network device, such as a home device in a home network 110, may be associated with a service according to an example embodiment of the invention. An example home device 102 described in these scenarios is a security camera 104, but any other home device is applicable. The user 105 of the camera 104 may have an account with service 106 that is accessible via the Internet 108. The photos taken by the camera 104 may be sensitive information, and thus should be bound to the owner's user account and not made visible to others. The user purchases the security camera 104 and attaches it to the home network 110, e.g., via a wired or wireless interface. In some cases, the Wi-Fi Protected Setup standard may already be in use, thus the initial Wireless Local Area Network (WLAN) configuration may only involve pushing two buttons.

As represented by path 112, the security camera 104 may silently and/or automatically, e.g., without requiring user input, connect to and register with the service 106 according to pre-programming of the camera 104. Neither the camera 104 nor the service 106 need to know anything about the owner/user 105 yet. Based on this connection 112, the service 106 may detect a public IP address of external interface 114 of NAT 116. The device 104 transmits to the service 106 its unique device identifier, e.g. serial number. The service 106 then stores the information, e.g., identifier of device 104, and the IP address in a database 118, which can determine where the registration originated. This registration 112 may be repeated for multiple pre-programmed services, e.g., Flickr™, Ovi™, Vox™, Yahoo™, Google™, etc., all at the same time. So, no matter which service the user ultimately prefers, it could appear at that service.

After locally setting up the security camera 104, a user manual may instruct the user 105 to log in to the service 106 to control the camera 104. To facilitate this log in, the user 105 may utilize a user device 120, such as a phone, cellular phone, personal digital assistant (PDA), mobile navigation device, mobile communication device, mobile email reader, Internet tablet, smart appliance, personal computer, server computer, media player, audio/video player, game device, digital cameras/camcorder, set top box, digital video recorder, television, and/or the like, or any combination of thereof. The user device 102 may include a browser or other program to access the service 106, and the user logs in using personal credentials, as represented by path 122. This login 122 may also include an initial registration with the service 106, such as in the situation where the user 105 has never accessed the service before, or has forgotten previous account credentials and needs to renew a password.

After user login/registration 122, the service 106 looks in the database 118 for previously registered one or more local network devices that match the current IP address as is being used for the registration 122. For example, the security camera 104 previously registered itself from the same NAT address 114, a match is found. The user 105 now sees the camera 104 in his/her account, and can adopt it as part of the service. After that, the camera 104 is bound to the user account. Based on this binding, there can be a direct utilization of the service 106 by the camera 104, and vice versa. For example, any photos take by the camera 104 may be uploaded to a private Web space hosted by the service 106. In another example, the user 105 can also control the camera 104 immediately in via the service 106, such as by using a browser of the computer 120.

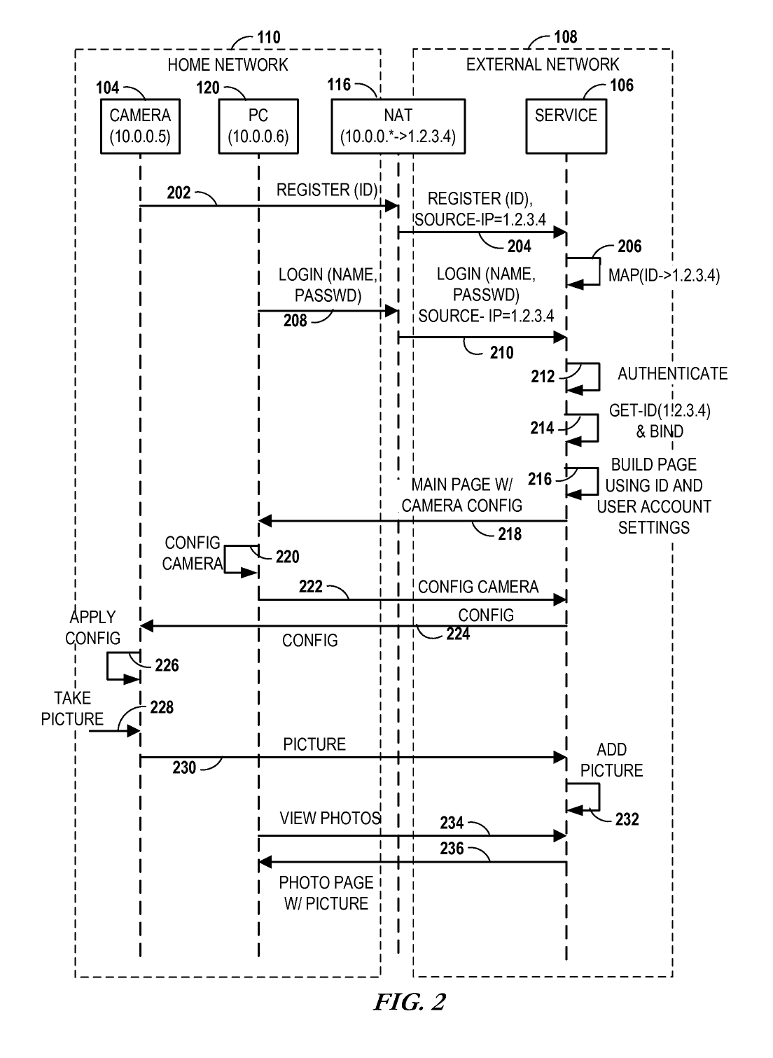

The operations similar to those described in relation to FIG. 1 are shown in a sequence diagram of FIG. 2, illustrating an example embodiment of the invention, wherein the same reference numbers are used to indicate analogous functional components. In this example, the local network 110, such as a home network, has a network address of 10.0.0.0/24, and the NAT 116 maintains a single public IP address of 1.2.3.4 for all devices of the network 110. Upon installation of the local network device 104, such as the security camera, the camera registers 202, 204 with the service 106 using a unique ID associated with the camera 104. Because the message 204 sent via the external network 108 includes the NAT's 1116 public IP address in network headers, the service 106 is able to map 206 the NAT IP to the unique ID of the camera 104.

The registration 202, 204 may involve sending more data than the ID of the camera 104. For example, hardware and software data related to the camera, e.g., model number, version, may be communicated to the service 106 so that the service 106 may obtain modules for using/controlling the camera 104. Such functional modules may be available at the service 106, via a third-party service, e.g., camera manufacturer/distributor), and/or from the camera 104 itself.

At some time after registration 202, 204, the user logs in, and/or initially registers, at 208, 210. In response to the login 210, the service 106 may authenticate 212 the user as is known in the art. Also, the public IP address of the NAT 116 is communicated to the service 106 via login message 210. This public address is the same as that detected at camera registration 204, even though a different user device 120, such as a personal computer (PC), originates the login 208. When receiving the login request 210, the service 106 examines the source IP address in the request 210 and uses the IP to look up 214 any previously registered device data. In this case, the lookup 214 would result in determining the ID of the camera 104 that was mapped 206 previously, and the camera 104 may be bound to the account at this time. The lookup 214 may also retrieve other data, such as modules used to communicate with the camera 104.

In response to successful authentication 212 and binding 214, the service 106 may then retrieve/build 216 a page for display at the user's device 120. Because the lookup 214 has presumably determined the camera's registration, the building 214 of the page will include features that allow access to the camera 104 via the service 106. The resulting page 218 is sent to the user device 120 for rendering. It should be noted that, for reasons of clarity and brevity, remaining interactions between the service 106 and the home network 110 are shown bypassing the NAT 116, although those of ordinary skill in the art will appreciate that such transactions will be processed via the NAT 116 if the NAT 116 is still acting as a gateway to the external network 108.

The user device 120 will render the page 218 which may provide links, controls, and the like, that enables configuring 220 the camera 104 via a user interface of the user device 120. This configuration 220 may be facilitated, for example, via presentation of Hypertext Markup Language (HTML) forms, embedded objects, e.g., Java™ Applets, Flash™, ActiveX™, etc), or any other user interface controls known in the art capable of being rendered in a browser or similar application.

The result of the configuration 220 is the sending of one or more configuration messages 222 to the service 106. In response, the service 106 may be able to directly or indirectly configure the camera 104, as represented by message 224 and configuration action 226. It will be appreciated that in some instances, the NAT 116, or other intermediary, may not, by default, allow the service 106 to directly access the camera 104 from the external network 108. For example, incoming connection requests directed to the camera 104 may be blocked.

There may be a number of ways to overcome potential blocking of the configuration messages 224 via the NAT 116 or other entities. For example, the NAT 116 may configured with port mapping to route connection requests from the service 106 to the camera 104 on a predefined port. In other examples, the service 106 may utilize the user device 120 to access the camera 104 if the user device 120 is still on the local network 110. For example, the page 218 may contain a data object that allows the user device 120 to directly configure the camera 104 via the local network 110. In another example, the user device 120 may establish a connection with both the camera 104 and the service 106, and a component of the page 218 may tunnel data to the camera 104 on behalf of the service 106. In yet another example, the camera 104 itself may periodically initiate a download of any new configuration parameters stored 222 on the service 106, and then apply 226 the parameter. In such a case, allowing incoming connection requests may not be necessary.

In addition to allowing configuration of the camera 104, the sequence in FIG. 2 may also allow the camera 104 to communicate directly with the service 106. For example, the camera 104 may detect an event 228 that causes the camera 104 to take a still picture or video. The event 228 may be in response to a timer, user input, sensor input, network command, etc. In response the event 228, the camera 104 may have been configured to post the picture to the user's account with the service 106, as represented by 230, 232.

After the pictures are added 232 to the account, user may view photo's 234, 236, from the home network 110 or elsewhere, assuming the user authenticates to the service 106 from another location. The service 106 may add 232 the picture to the user's account by default, e.g., detecting the public IP address of the NAT 116, or by explicit authentication of the camera 104 with the service using credentials of the users. Those credentials may be supplied to the camera 104, for example, during user configuration 226. The credentials may be stored at the camera 104 or some other element of the home network 110, e.g., NAT 116, authentication server, etc.). Having the camera 104 to authenticate with the service 106 may also require the camera 104 to update the credentials when the user makes changes to his/her account. However, because the service 106 has already established a trust relationship with the camera 104, e.g., via registration 202, 204, the service 106 may be able to update the credentials managed by the camera 104, either automatically or in response to user request/verification. In other cases, the camera 104 and service 106 can use an authentication mechanism that is independent of the user credentials, and therefore need not change if the user changes a password, for example.

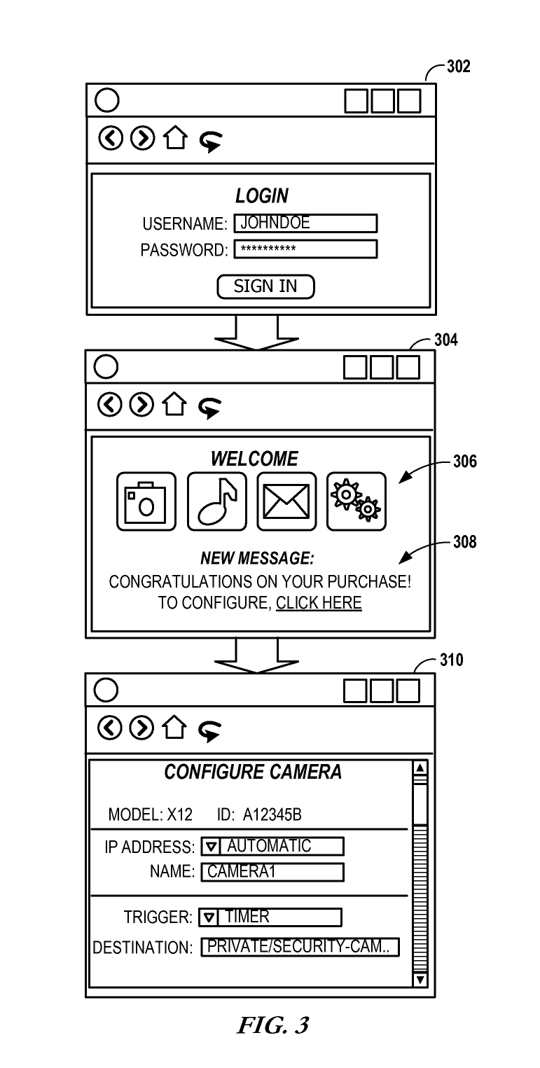

Because the binding of the local network devices 104 and the user account can be done automatically using the IP address, the user does not have to manually enter any binding information. The local network devices are added to the user account immediately when the user logs in using a Web browser and chooses to adopt them. In reference now to FIG. 3, a block diagram shows a sequence of user interface screens that may be shown in the user device 120 and seen by the user when configuring the local network device according to an example embodiment of the invention. Screen 302 illustrates how a login, e.g., to facilitate login/registration 122, 208, 210 to service 106 as seen in FIGS. 1-2, may appear. After the user is authenticated, screen 302 may appear, e.g., such as main page 218 in FIG. 2, that gives user general service options via icons 306, and includes a message 308 that indicates a previously installed device has registered with the service. Selection of a link in the message 308 results in configuration screen 310 that facilitates configuring the device, e.g., configuring 220 of camera 104 as shown in FIG. 2).

The configuration screen 310 may be provided in various ways. For example, the service 106 may include its own up-to-date, customized controller for the local network device 104, such as the security camera. Such controller may be provided as markup language content or binary objects that are embedded in the page 310. In other embodiments, the camera controls seen in screen 310 may be provided by the camera 104 itself, and embedded in a page provided by the service 106. In one embodiment, this may involve providing an HTML frame in one of the service provider's pages, and a link to the local address of the controlled device 104 is used by the browser to download the controls, e.g., binaries and/or markup documents, and display them in the frame. In this way, the user can control the local network device 104 via the service 106 without having to determine the local IP address of the device, type that local IP into a browser address bar, and/or bookmark the local address for later access.

In the above described examples, the user logs into a network service, e.g., service 106, at least once from the same network, e.g., home network 110, to which the configured local network device, e.g., camera 104, is locally coupled. Thus a user may use a user device, e.g. a home PC 120 or the like, to log in at least once after installing the device. If the user logs in to service 106, e.g., from work, before the device binding 214 with the service is completed, the user may not see the newly installed device in the service. However, after logging in from the home network 110 at least once after device registration 208, 210, 212 is complete, the configured device is then bound to the user account and visible thereafter regardless of where the user logs in from.

Although the configured device in the above example describes and includes a security camera, it will be appreciated that the same concept are directly applicable to one or more other local network devices, such as home devices, household appliances, phones, media players, audio/video players, sensors, cellular phones, personal digital assistants (PDA), mobile navigation devices, mobile communication devices, mobile email readers, Internet tablets, smart appliances, personal computers, server computers, game devices, digital cameras/camcorders, set top boxes, digital video recorders, televisions, display devices, printers, home stereo systems, and/or the like, or any combination of thereof. For example, such a service 106 may be useful for using the local network devices with a limited user interface.

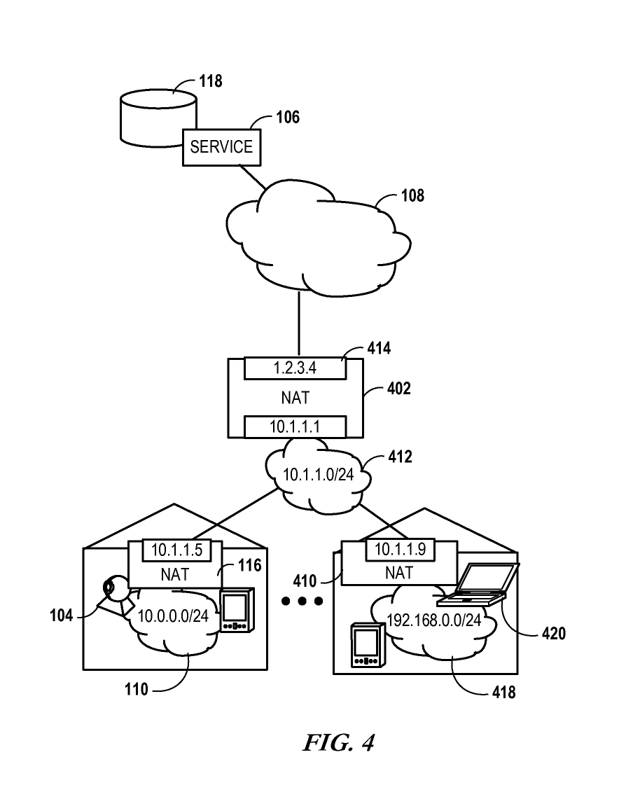

As shown in FIGS. 1 and 2, a single associated IP address is obtained from a NAT configuration and used to link home devices with service accounts. Depending on the network arrangement, however, there may be obstacles to this approach. In some places, it may not be possible to get a public IP address that encompasses just one home. In FIG. 4, a block diagram illustrates an example embodiment of the invention where a single IP address encompasses multiple homes.

In FIG. 4, a service provider NAT 402 provides access to external networks 108 for multiple local networks 110, 418, such as home networks, other entities/partitions such as businesses networks, vehicle networks, local area networks (LAN), each having respective NATs 116, 410. The NATs 402, 116, 410 form an intermediate network 412 that may use non-Internet routable addresses. The NAT 402 has a public network interface 414 that uses an Internet routable IP address for all of the homes of network 412. In such a case, if camera 104 were registered with service 106 from network 110, then the camera 104 may be accessible by somebody from network 110 using device 420 on home network 418, presuming the individual from network 110 also has an account with service 106. This type of situation may make it difficult to reliably bind devices to a user account by using just the IP address.

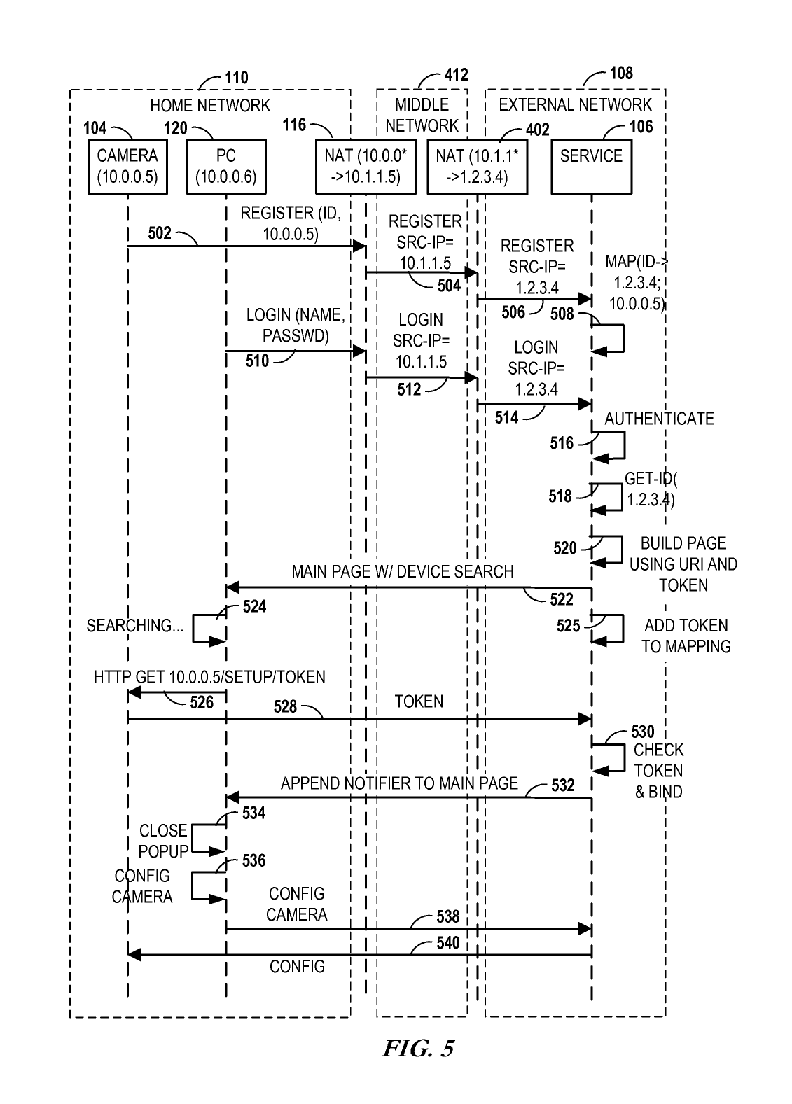

In reference now to FIG. 5, a sequence diagram illustrates an example embodiment of the invention, and an alternate technique for linking a home device with user account usable in an architecture such as in FIG. 4. As in FIG. 2, the camera 104 performs an initial registration 502, 504, 506 targeted for service 106. In this case, the registration 502, 504, 506 includes both the device ID and a local IP address of camera 104 on a local network 110, such as on a home network. The service 106 determines the public IP address from message 506 and in response the service 106 maps 508 the device ID to both the public and private IP addresses. It should be noted that the registration 502, 504, 506 may also include other local networking identifiers such as network address, local netmask, Media Access Control (MAC) addresses, etc., that may assist in locating the device 104 on network 110.

Thereafter, a login/registration/authentication 510, 512 514, 516 from the use device 120 to service 106 results a retrieval 518 of local network devices associated with the public IP address. Note that, unlike the scenario in FIG. 2, a match resulting from the retrieval does not yet result in binding of the device to the user account. This is because the login 514 could originate from another home network behind NAT 402.

As before, the service builds 520 a response page which is sent 522 to the requesting user device 120 in response to the login/authentication 510, 512 514, 516. The page 520 in this case may include a Universal Resource Identifier (URI) corresponding to the registered local network device 104 and a specially generated token. The main page 522 sent to the PC 120 may cause the user device 120 to perform a device search 524 based on the URI of the local network device 104. For example, the main page 522 may cause the PC to pop-up 524 a window, either automatically or in response to a user request/confirmation, stating that a search for new devices is being performed. This window, or underlying software that causes the window to pop-up, may make reference to a corresponding to camera 104 URI such as “http://10.0.0.5/setup/unique-token.”

In response to the search 524, the user device 120 makes an HTTP request 526 to the IP address, which corresponds to camera 104 in this case, and the token is passed to the camera 104, e.g., using an HTTP GET or PUT. This token may have been generated when the main page 520 was generated by the service 106, and the service 106 may further add 525 the token to the mapping, e.g., mapping 508 of ID and IP address, for later reference after generating the main page 520. The token may also be tied to the unique ID of the camera 104, e.g., via a hash of the ID, using public key infrastructure cryptography, etc., so that the camera 104 can verify that the token is uniquely targeted to the camera 104.

In response to the local message 526, the camera 104 may return a simple HTTP status code, e.g., Status: 200 OK, (not shown) to the user device 120 along with an empty document. The camera 104 may optionally verify (not shown) the token to ensure it is tied to the camera's ID used at registration 502. The camera 104 then passes the token to the service 106 via message 528. The service 106 checks/verifies 530 the token is the one stored at 525. If so, a notifier is appended 532 to the main page shown in PC 120 to indicate that to that the camera 104 is detected. In response to this message 532, the popup, if one is used, is closed 534 and user initiated configuration 536, 538, 540 may proceed in the various manners as described in relation to FIGS. 2 and 3.

It should be appreciated that the update 532 of the main page may occur using technologies such as Asynchronous JavaScript and XML (Ajax), Java Applets, ActiveX controls, etc. In other scenarios, the camera 104 may, in response to the HTTP GET 526, send a response to the user device 120 that causes the user device 120 to reload the main page from the service 106, e.g., after some passage of time to ensure the token can be verified 530. The reloaded page will include camera configuration links/controls, such as in screens 304, 310 of FIG. 3.

Note that the use of browser pop-ups 524, 534 is one example implementation method. The pop-up implementation should work on most browsers, without the need for a certain browser type/settings, or relying on add-on software. Searching for the device 104 may also be implemented transparently with Ajax, although some browser implementations may not cross-script to private IP addresses. Other technologies like Flash and Java applets could also be used.

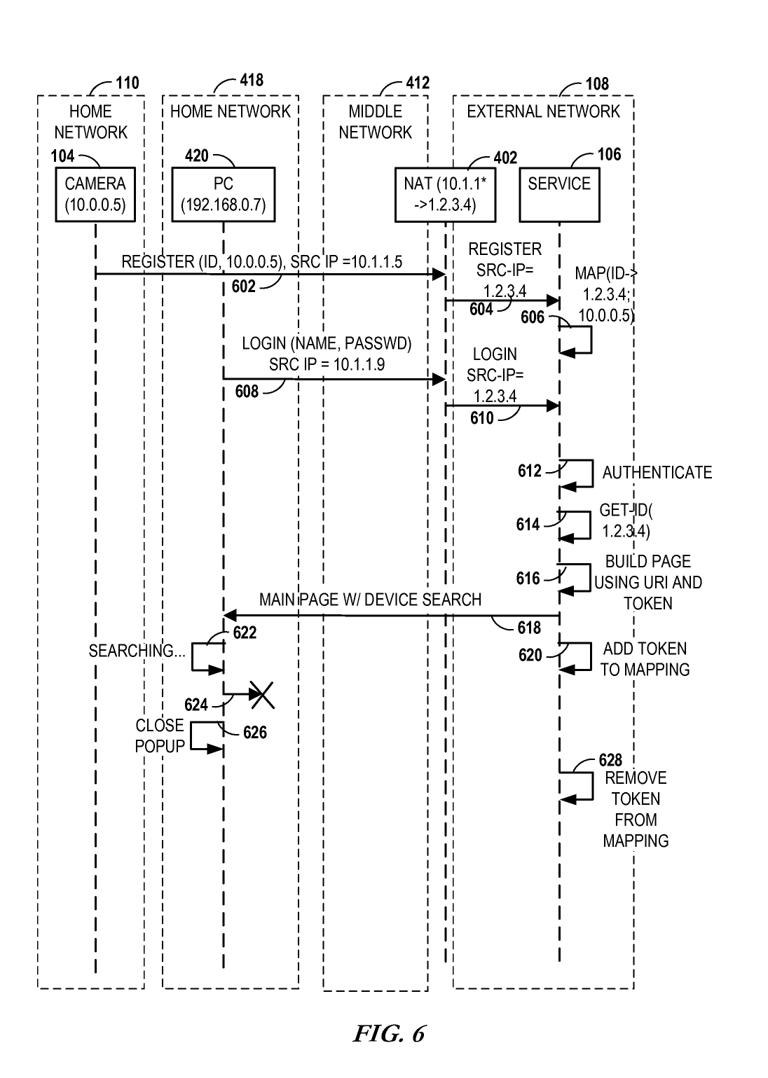

In reference now to FIG. 6, a sequence diagram illustrates an example embodiment according to the multiple-NAT arrangement shown in FIG. 4. In this embodiment, individuals of local networks, such as home networks 110, 418, both have accounts on service 106, and also both appear to the service 106 have the same public IP address due to the use of NAT 402 by both networks 110, 418. In the sequence diagram of FIG. 6, the home NATs 116 and 410 shown in FIG. 4 are omitted for purposes of clarity, although these NATs 116, 410 may still perform address translation for networks 110, 418 as previously described.

In this case, the local network device 104 such as the security camera, is registered 602, 604, 606 with the public IP of NAT 402 similar to previous scenarios. However, before the security camera 104 is bound to the correct account, user of user device 420 logs in 608, 610, 612. Log in message 610 is determined 614 to come from the same public IP as the camera 104, and the main page is built 616 and sent 618 to the user device 420. The token is also stored 620 by the service 106 for later reference. The browser of the user device 420 pops up 622 a search dialog, or uses other methods as described herein, and attempts to connect to the camera 104. In this case, the camera 104 is inaccessible, at least because the camera 104 is physically located on a different network media 110. Therefore the connection attempt fails 624 and the pop up is closed. Eventually, the service 106 may remove 628 the token from the mapping because there was no response from the target device 104.

Even though in this example, the networks 110, 418 use different network addresses, e.g., 10.0.0.0/24 for network 110 and 192.168.0.0/24 for network 418, the result should be the same, e.g., connection 624 should fail, if both networks use the same network address space. Even if the networks 110, 418 used the same address space, unless the home network 418 has a server with the same IP address of the camera 104 and uses the same ports and protocols, the attempt 624 should fail as being unable to connect. Even if by coincidence the network 418 had a device identical to camera 104 that used the same IP address as camera 104, if the token in the message 618 is tied to a unique device ID of camera 104, the identical device on network 418 receiving the token may be configured reject the request and not pass the token to the service 106.

The example embodiments described above use various ways of binding a home device to an account using a NAT public address. One reason that NATs are popular is because is that, with IPv4 which is still by far the most widely deployed version of IP, there may not be enough IP addresses to allocate to each and every network device in the world. If a home network user has the option of using IPv6, alternate ways of binding a home device to an Internet account may be possible. For example, the IPv6 address prefix may be used for binding, similar to the case of a single NAT as shown in FIGS. 1 and 2. In another example, a hostname and/or domain name of a public network interface may be determined via a reverse Domain Name Service (DNS) lookup and bind an account to one or both of the hostname and any IP addresses associated with the hostname.

Although the NAT public address may be used to initially bind the home device to the account, the binding should not be affected if the NAT public address changes. For example, home IP addresses are often dynamically allocated, and may change over some period of time or in response to an event, e.g., power cycling). As long as the NAT public IP address remains the same between device registration, e.g., messages 202, 204 in FIG. 2, and user login, e.g., login 208, 210 in FIG. 2), the binding will take effect as described and will not be affected if the NAT public address changes. This is because after the binding the unique device ID may be used by the service to manage incoming data from the home device, e.g., to place in a user account and restrict access.

However, if the service and home device depend on the NAT's public IP address for later interactions, e.g., remote access configuration of the home device), then the home device and/or service may utilize mechanisms to detect these changes. For example, the home device may send messages to the service at regular intervals to verify the public IP has not changed. Such messages may be similar to the registration messages, e.g., messages 202, 204 in FIG. 2, except that the purpose of the messages is just for confirming no change in public IP address. These messages can be sent at an appropriate interval, such as an average Dynamic Host Configuration Protocol (DHCP) IP address lease time. It should be noted that it expected that user devices accessing the service, e.g., PC 120, may originate from different address spaces, because the user may access the service from anywhere. The user needs just to ensure that the initial login, e.g., login 208, 210 in FIG. 2, occurs from the same address as the home device, and the binding may be maintained, e.g., visible in service content, for subsequent logins no matter where the logins originate.

It will be appreciated that Web proxy servers may also interfere with the binding as described above. Proxy servers expose a single IP address to the public Internet, and make service requests, e.g., HTTP request, on behalf of numerous clients. Home configurations may not usually require the use of proxy servers, but in corporate settings they are often used. There may be workarounds for this scenario, however. For example, many HTTP proxies expose the client's IP address as an HTTP header “x-forwarded-for.” Assuming this functionality and the local network having a NAT in place, the scenario is reduced to a plain single NAT case as shown in FIGS. 1 and 2.

There are many home devices that may intuitively be owned by the whole family. In the various example embodiments shown above, devices are bound using the home IP address, so they may become visible for the whole family by default. Depending on the device and the details of the service, a single user may adopt the device in his/her account, or it could be included in every family member's account when they log in. As an example of the latter, in FIG. 2 the ID lookup 214 may occur for every log in attempt, even if the camera 104 has already been bound to one user account. A similar adaptation could be made the scenarios shown in FIGS. 5 and 6.

For finer levels of restriction, the family member may have some agreement how the devices are taken into use and who should adopt them in their user account. One approach that allows this is to only allow a first family member to adopt the device when logging in. To allow access to other family members, the first member would grant this access separately through the network service. The various embodiments may allow the user to choose between account sharing or default linking of all accounts. For example, in FIG. 2 the first user who accesses the configuration 220 may have an option to limit further linking of the camera 104, in which case the service 106 may remove the mapping that was made at 206.

Once the devices are configured in the web service, they can publish data through it. For example, security camera images can be viewed on the web service by logging in as a user who has adopted the device in his account. As an additional feature, it may be possible to share the device user interface, e.g., web page access, with a neighbor for example, for keeping an eye on the home while the family is on holiday. This may be done by temporarily binding the device with the neighbor's user account. In such a case, this access is may revoked after returning home. In such a case, the binding may have different levels of granularity so that, for example, the neighbor could view camera images but not change configurations of the camera.

The example embodiments above facilitate simple configuration of home devices with minimal user interaction. There is no need for the user to type in identifiers, addresses, usernames, passwords etc. Various embodiments may be easy to integrate to existing networks, e.g., nothing needs to be installed on the user's PC or the device, and most of the logic can be on the service side. The binding of home devices to online services can also bring a richer user experience to the service, and enable the user to get more value and functionality out of the home device. There may be advantage to the service providers, such as being able to obtain more accurate information about users and their devices, and easing tasks such as error statistics and applying software updates.

The technical effects of such a system may include the automatic provision of up-to-date control of such home device via a centrally controlled Web service. Such service-provided controls have the potential to be more reliable that the shipped version of software that may be included with the device. Another technical effect of the various embodiments described herein is increasing long term reliability of home devices by reducing chances for authentication failure when account credentials are changed.

Those of skill in the art will appreciated that many variations are possible in view of the above descriptions. For example, device-specific identifiers used in binding devices to accounts may product codes, serial numbers, phone numbers, International Mobile Equipment Identity (IMEI), and may be utilized without requiring that the user to type in some identifier of either the device (e.g., product code) or the user account (e.g., credentials).

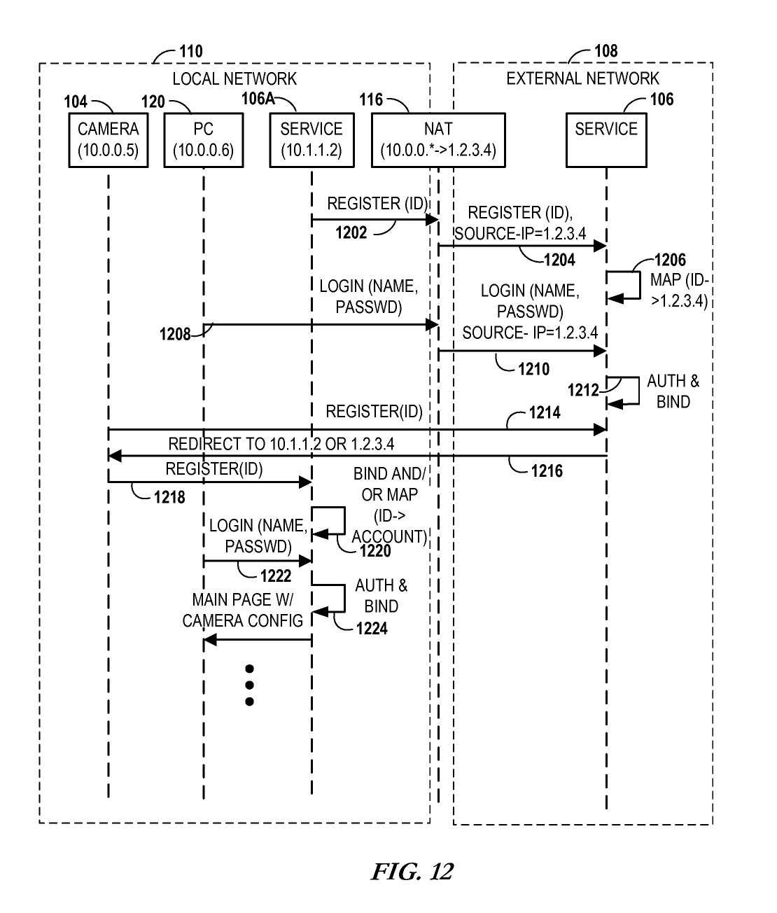

In another variation of the example embodiments shown in FIGS. 1-6, portions of the service 106 may reside inside the local network 110. This is shown in FIG. 12, which includes a sequence diagram according to an example embodiment of the invention. An internal service component 106A may run on any device of local network 110. The internal service 106A may be associated with external service 106, such as where the internal service 106A utilizes the account credentials of service 106 to authenticate the user. For example, service 106A may include a home photo gallery that is installed on a user device at home. This photo gallery may be accessible directly from the external network 108, and/or integrated/combined with other services provided by external service 106. In either case, the user may be able to seamlessly access both services 106, 106A using the same credentials and/or account identities.

If the service 106A is accessible via the external network 108, it may be placed on a protected network segment to provide an additional layer of security. Such network segment may be referred to as a Demilitarized Zone (DMZ). A DMZ may include a physical or logical subnetwork that contains and exposes external services to an untrusted network, such as the Internet. A DMZ may be implemented using one or more firewalls, and may involve passing all incoming traffic to a particular subnetwork that is isolated from the remainder of the protected local network. This is represented in FIG. 12 by service 106A residing on a different local network address space, e.g., 10.1.1.0/24, than other devices within network 110. The service device 106A may still be considered physically/logically part of the local network, and may be accessed from the network 110 using its local address and/or public address of the NAT 116. The service 106A may be set up, such as using a web browser of user device 120. In response to set up, the service 106A register 1202, 1204 with service 106, causing the NAT public network identifier to be mapped 1206 with service 106A. This mapping may then be then used by devices such as 104 to find the service 106A based on a known ID of service 106A, e.g., “PhotoGalleryService.”

As shown in FIG. 12, the user may login in 1208, 1210 to service 106, causing the service 106 to authenticate and bind 1212 the service 106A to the user account. In an alternate embodiment, the local service 106A may forgo registration 1202, 1204, and the user logs in (not shown) to the service 106 via the local service 106A. In that case, the local service 106A may be able to communicate both the user account data and public network identifier in a single operation, and thereby bind the service 106A to the account.

After service 106A is bound to the user account, local device 104 is installed on local network 110. A registration 1214 of device 104 with service 106 results in communication 1216 that redirects the request to the local service 106A, using an address or other identifier appropriate for device 104 to access service 106A. This redirection 1216 may occur instead of or in addition to the service 106 binding the device 104 to the account. For example, the registration 1214 may make reference to an ID of service 106A, e.g., “PhotoGalleryService,” in which case the redirection 1216 may be triggered based on the previous mapping 1206. The local device 104 then registers 1218 with the local service 106A, which maps 1220 the device 104 to the user account. This mapping 1220 may automatically bind the device 104 to the account, or binding may require a user log in 1222 and authentication 1224. Thereafter, the service 106A and device 104 may interact similar to the interactions described in FIGS. 2, 5, and 6. The device 104 need not contact external service 106 anymore, and may, if desired, interact exclusively with the local service 106A service installed at home.

It should be appreciated that the registration 1202, 1204 of local service 106A with external service 106 may also enable service 106A to interact with service 106 in a manner similar to device 104 and service 106 in the above scenarios. For example, a user may configure service 106A via service 106 using user device 120 inside or outside the home network 110. The service 106A may generate content/data that is communicated to service 106 and associated with the user account. Access of this content/data may be in accordance with privileges and settings of the account on service 106, and those privileges/settings may be different than ones on local service 106A.

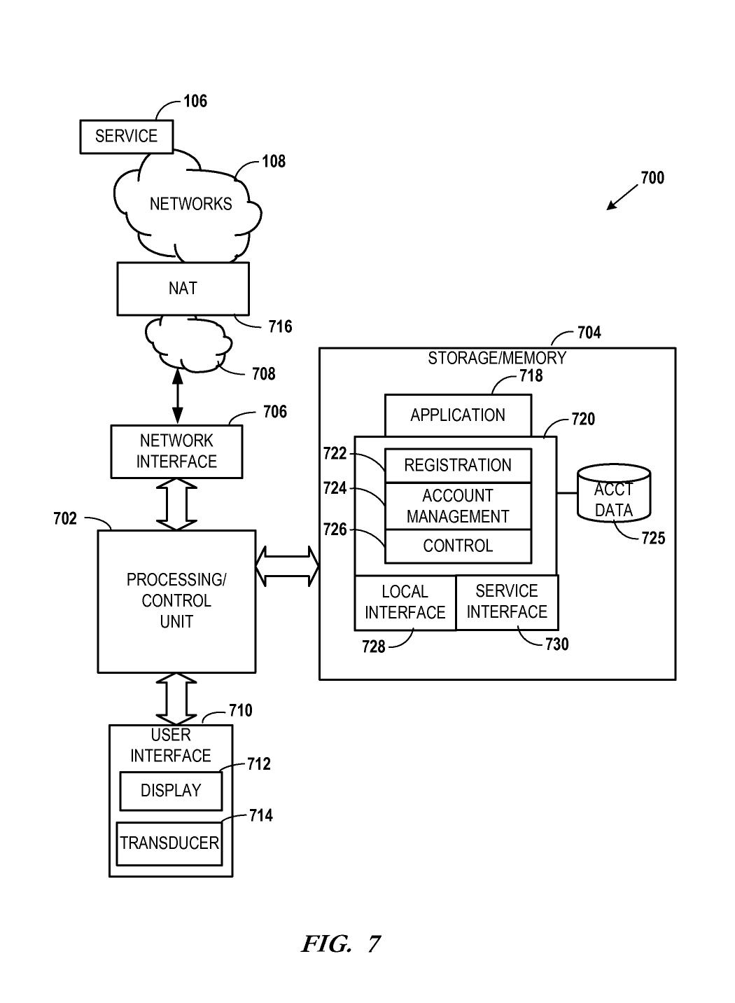

Any combination of computing hardware used to implement the functionality of a local network device, such as home device, as described herein. In reference now to FIG. 7, an example embodiment is illustrated of a representative local network apparatus 700, such as a home apparatus, capable of carrying out operations in accordance with example embodiments of the invention. Those skilled in the art will appreciate that the example home apparatus 700 is merely representative of general functions that may be associated with such devices, and the apparatus 700 may include features associated with one or both of fixed and mobile computing devices. Apparatus 700 may include local network devices 102, 104 as shown and described in relation to FIGS. 1-6.

The processing unit 702 controls the basic functions of the device 700, and may include one or more specialized or general-purpose logic units for processing instructions. The instructions may be stored with the processing unit 702 and/or in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the apparatus 700. The relevant software for carrying out operations in accordance with the present invention may also be provided to the storage/memory 704 by computer readable medium and/or computer program products. Such software may also be transmitted to the apparatus 700 via data signals, such as being downloaded electronically via one or more networks, such as the Internet and intermediate wireless network(s).

The home apparatus 700 may include hardware and software components coupled to the processing/control unit 702 for performing network data exchanges. The apparatus 700 may include multiple network interfaces 706 for maintaining any combination of wired or wireless data connections. Network interface circuitry 706 may include a digital signal processor (DSP) employed to perform a variety of functions, including analog-to-digital (A/D) conversion, digital-to-analog (D/A) conversion, speech coding/decoding, encryption/decryption, error detection and correction, bit stream translation, filtering, etc. The network interfaces may include a transceiver, generally coupled to media and/or an antenna that transmits outgoing signals and receives incoming signals associated with the apparatus 706.

The network interfaces 706 may include the ability to communicate via data paths using any manner of data transmission medium and protocols, including wired and wireless short-range and wide-range communication mediums/protocols. Examples of such media/protocols include Universal Serial Bus (USB), Bluetooth, Ethernet, 702.11 Wi-Fi, IRDA, Ultra Wide Band (UWB), WiBree, radio frequency identification (RFID), Universal Plug and Play (UPnP), cellular data protocols, etc. The network interfaces 706 may be capable of communicating via one or more home networks 708 and external networks 108 and/or via direct and/or peer-to-peer communications links. The networks 108, 708 may include any combination of mobile service provider networks, local networks, and public networks such as the Internet.

The processor 702 may also coupled to user-interface hardware 710 associated with the apparatus 700. The user-interface 710 of the apparatus 700 may include, for example, a display 712 such as a liquid crystal display and a transducer 714. The transducer 714 may include any device capable of receiving user inputs. The transducer 714 may also include sensing devices capable of producing media, such as any combination of text, still pictures, video, sound, etc. Other user-interface hardware/software may be included in the interface 712, such as keypads, speakers, microphones, voice commands, switches, touch pad/screen, pointing devices, trackball, joystick, vibration generators, lights, etc. These and other user-interface components are coupled to the processor 702 as is known in the art.

The program storage/memory 704 may include operating systems for carrying out functions and applications associated with functions on the apparatus 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 704 of the apparatus 700 may also include software modules for performing functions according to embodiments of the present invention.

The program storage/memory 704 in this example includes various components that enable registering the apparatus 700 with a network service 106 via networks 708, 108 that may be coupled via one or more NATs 716. Generally, the apparatus 700 may have one or more primary applications 718 that perform the primary function of the apparatus 700. Such functions may include any combination of sensing, data capture, rendering, communication, control, gaming, and other functions associated with existing and future networkable devices for the home and office.

The applications 718 may interface with a service module 720 that handles communications with the service 106. The service module 720 may act as a bridge between the applications 718 and the service 106 in some situations. The service module 720 may include sub-modules 722, 724, 726 that respectively handle tasks relating to device registration, account management, and device control. The registration sub-module 722 may cause the apparatus 700 to contact the service 106 on initial installation such as shown in the examples of FIGS. 1, 2, 5, and 6. This may involve obtaining an initial network configuration, determining a URI of the service, and commencing communications at the appropriate time and/or in response to some event.

The account management sub-module 724 may manage various aspects of communicating with the service 106 after the apparatus 700 has been bound to a user account of the service 106. For example, the apparatus 700 and service 106 may agree on some protocol for authentication and data security when sending data to user account with service 106. The registration and account management sub-modules 722, 724 may utilize an account management database 725 for storing data related to registration and account access. This data 725 may include unique identifiers of apparatus 700, authentication data for accessing service 106, tokens used in verifying registrations, e.g., as shown in the examples of FIGS. 5 and 6), etc.

The control sub-module 726 may provide for control and configuration of the apparatus 700 via the service 106. The control sub-module 726 may receive commands via the local and/or external networks 708, 108, apply commands to the apparatus, e.g., via applications 718 or other control modules not shown), communicate status via the local and/or external networks 708, 108, etc. The control sub-module 726 may also provide data objects that allow another device to control the apparatus 700. Such data objects may include markup language documents and/or binary executables. For example, the control sub-module 726 may include a Web server that allows configuration via HTML documents and HTTP commands.

The functions of the service module 720 may utilize a generic service interface 730 that may include functions and protocols associated with the service 106. A local interface 728 may also provide local access to those functions, such as via user interface hardware 710 or non-network data interfaces such as USB. The local interface 728 may also provide other functions related to the local network 708, such as configuration of the NAT 716 to enable remote access to control functions of the apparatus 700 via external network 108.

The apparatus 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. Thus, the present invention is applicable in any known computing structure where data may be communicated via a network.

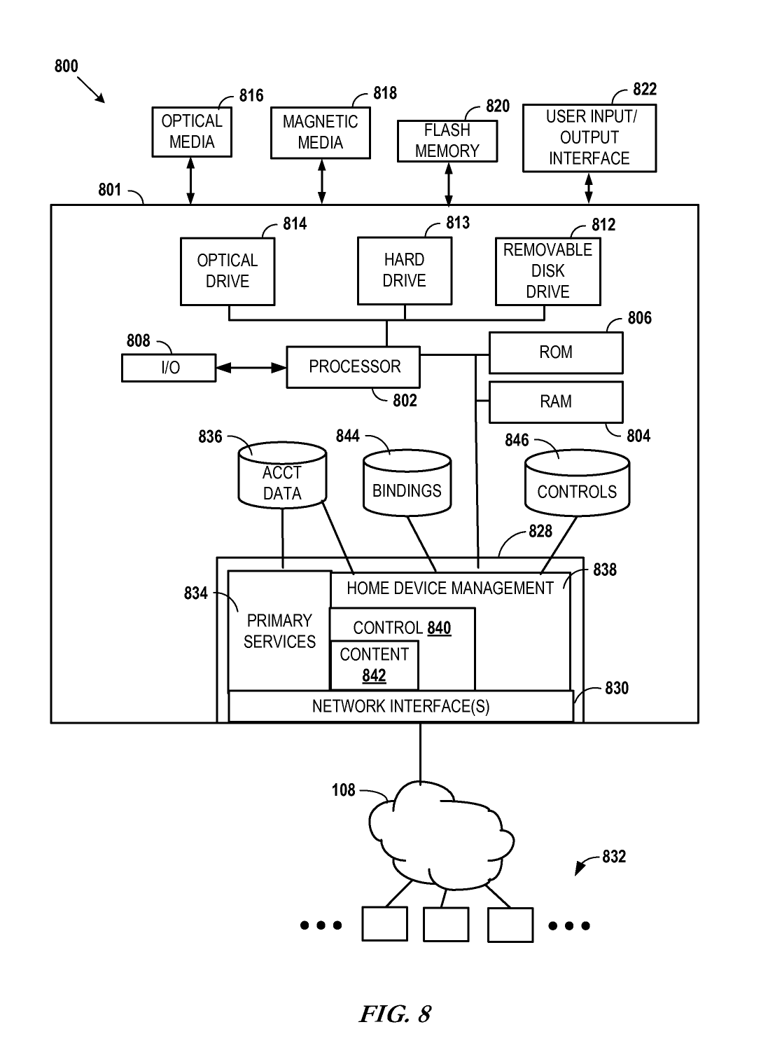

Many types of apparatuses may be able to perform roles as servers that provide services such as described above in relation to service 106 and equivalents thereof. In reference now to FIG. 8, illustrating an example embodiment of the invention, a block diagram provides details of a network service 800 that facilitates binding local network devices, such as home devices, to user accounts. The service 800 may be implemented via one or more conventional computing arrangements 801. The computing arrangement 801 may include custom or general-purpose electronic components. The computing arrangement 801 include one or more central processors (CPU) 802 that may be coupled to random access memory (RAM) 804 and/or read-only memory (ROM) 806. The ROM 806 may include various types of storage media, such as programmable ROM (PROM), erasable PROM (EPROM), etc.

The processor 802 may communicate with other internal and external components through input/output (I/O) circuitry 808. The processor 802 may include one or more processing cores, and may include a combination of general-purpose and special-purpose processors that reside in independent functional modules, e.g., chipsets). The processor 802 carries out a variety of functions as is known in the art, as dictated by fixed logic, software instructions, and/or firmware instructions.

The computing arrangement 801 may include one or more data storage devices, including removable disk drives 812, hard drives 813, optical drives 814, and other hardware capable of reading and/or storing information. In one embodiment, software, e.g., computer program products, for carrying out the operations in accordance with the present invention may be stored and distributed on optical media 816, magnetic media 818, flash memory 820, or other form of media capable of portably storing information. These storage media may be inserted into, and read by, devices such as the optical drive 814, the removable disk drive 812, I/O ports 808 etc. Software may also be transmitted to computing arrangement 801 via data signals, such as being downloaded electronically via networks, such as the Internet. The computing arrangement 801 may be coupled to a user input/output interface 822 for user interaction. The user input/output interface 822 may include apparatus such as a mouse, keyboard, microphone, touch pad, touch screen, voice-recognition system, monitor, LED display, LCD display, etc.

The service 800 is configured with software programs that may be stored on any combination of memory 804 and persistent storage, e.g., hard drive 813). Such software may be contained in fixed logic or read-only memory 806, or placed in read-write memory 804 via portable computer-readable storage media and computer program products, including media such as read-only-memory magnetic disks, optical media, flash memory devices, fixed logic, read-only memory, etc. The software may also placed in memory 806 by way of data transmission links coupled to input-output busses 808. Such data transmission links may include wired/wireless network interfaces, USB interfaces, etc.

The software generally includes instructions 828 that cause the processor 802 to operate with other computer hardware to provide the service functions described herein. The instructions 828 include one or more network interfaces 830 that facilitate communication with home devices NAT-protected home networks 832 via external networks 108. The network interface 830 may include a combination of hardware and software components, including media access circuitry, drivers, programs, and protocol modules.

The service 800 may include primary service modules 834 that provide functionalities that may be associated with a general purpose Web account. The primary services 834 may include, but are not limited to, and combination of email, text messaging, multimedia messaging, news feeds, mapping, navigation, multimedia sharing, advertising, calendar/contacts management, document editing/management, games, etc. Users maintain accounts with the primary services 834, as reflected by account database 836. Account data 836 may include authentication data, user profile data, content customization data, and any other data that may be unique to individuals who establish service accounts.

In the example embodiment, the primary services 834 are augmented by home device management services 838. The home device management services 838 integrate command, control, and content creation of home devices, e.g., apparatus 700 in FIG. 7, with primary services 834 of individual users. A control module 840 may allow control of the devices via the service 800, either via commands/messages issued from the service apparatus 800, or by facilitating a user terminal apparatus, e.g., PC 120 in FIG. 1, to configure the home devices by only logging into primary services 834. Similarly, a content module 842 may receive content generated by the home devices and appropriately integrate that content into the primary services 834. Content integration by module 842 may involve any combination of retrieving, formatting, rendering, annotating, storing and otherwise managing content in a manner appropriate to various ones of the services 834. Content integration by the module 842 may also control access to the content, e.g., by restricting access based on account data 836 such as identities and express, implied and granted privileges.

The home device management services 838 may rely on databases such as account data 836, device/account bindings 844, and controls 846. The bindings 844 may link unique IDs of home devices with one or more NAT public IP address associated with home networks 832 based on device registrations. These public IPs may also be associated with user logins that are verified via the primary services module 834, and provide an indicator that the logged in user is on the same home network as the registered device.

Once a home device is bound to the account, one task of the user may be to configure the home device. The controls database 846 may include any combination of documents, descriptions, programs, user interfaces, etc., that allow remotely controlling the home device via the service 800. The controls database 846 may be populated by device manufacturers, users, independent developers, and/or the registered home devices themselves, e.g., transmitted as part of device registration).

For purposes of illustration, the operation of the service 800 is described in terms of functional circuit/software modules that interact to provide the described results. Those skilled in the art will appreciate that other arrangements of functional modules are possible. Further, one skilled in the art can readily implement such described functionality, either at a modular level or as a whole, using knowledge generally known in the art. The computing structure 801 is only a representative example of network infrastructure hardware that can be used to provide location-based services as described herein. Generally, the functions of the computing service 800 can be distributed over a large number of processing and network elements, and can be integrated with other services, such as Web services, gateways, mobile communications messaging, etc. For example, some aspects of the service 800 may be implemented in user devices via client-server interactions, peer-to-peer interactions, distributed computing, etc.

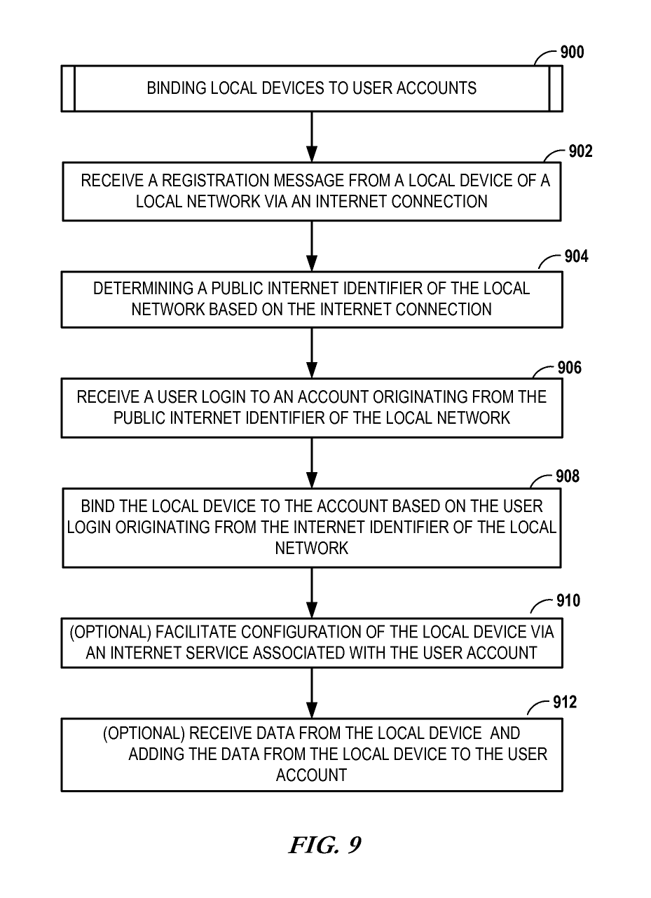

In reference now to FIG. 9, a flowchart illustrates a procedure 900 according to an example embodiment of the invention. The procedure 900 involves receiving 902 a registration message from a local network device of a local network via an Internet connection. A public Internet identifier of the local network is determined 904 based on the Internet connection. A user login to an account is received 906. The user login originates via the public Internet identifier of the local network. The local network device is bound 912 to the account based on the user login originating from the public Internet identifier of the local network. Configuration 910 of the local device via an Internet service associated with the account may optionally be facilitated. Receiving 912 data from the local device and adding the data from the local device to the user account may also be facilitated.

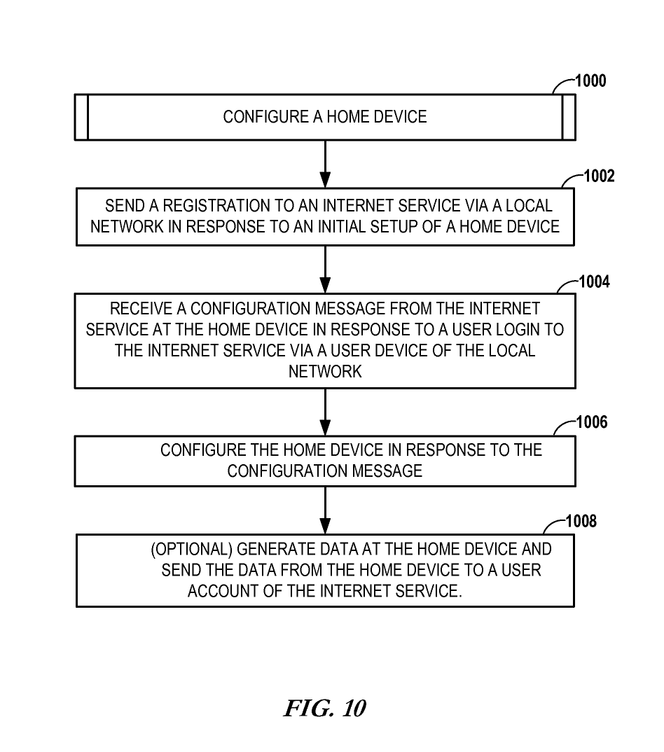

In reference now to FIG. 10, a flowchart illustrates a procedure 1000 according to an example embodiment of the invention. A registration is sent 1002 to an Internet service via a local service in response to an initial setup of a local device. A configuration message is received 1004 at the local device in response to a user login to the Internet service via a user device of the local network. The local device is configured 1006 in response to the configuration message. Optionally, data may be generated 1008 at the local device and sent from the local device to a user account of the Internet service.

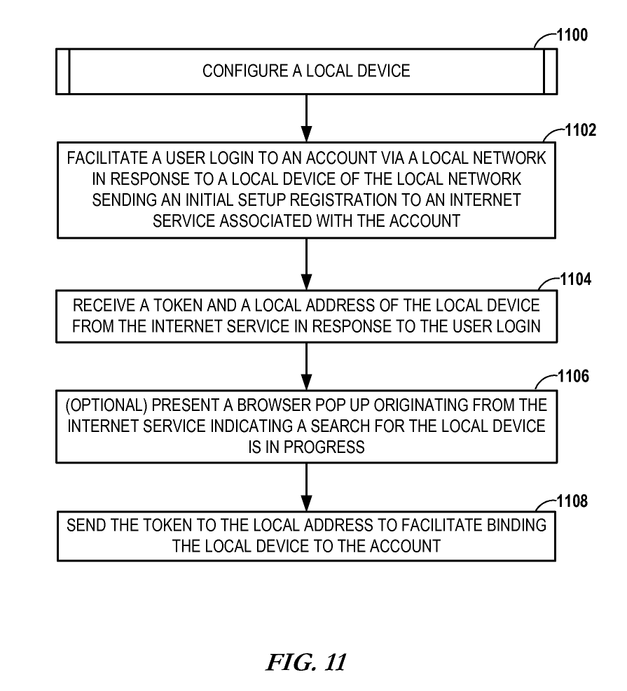

In reference now to FIG. 11, a flowchart illustrates a procedure 1100 according to an example embodiment of the invention. The procedure may be performed in response to a local device of the local network sending an initial setup registration to an Internet service associated with an account. The procedure 1100 involves facilitating 1102 a user login to the account via a local network. A token and a local address of the local device are received 1104 from the Internet service in response to the user login. Optionally, a browser pop up originating from the Internet service may be presented 1106 to indicate a search for the local device is in progress. The token is sent 1108 to the local address to facilitate binding the local device to the account

Any of the steps described or illustrated herein may be implemented using executable instructions in a general-purpose or special-purpose processor and stored on a computer-readable storage medium, e.g., disk, memory, or the like, to be executed by such a processor. References to ‘computer-readable storage medium’ and ‘computer’ should be understood to encompass specialized circuits such as field-programmable gate arrays, application-specific integrated circuits (ASICs), signal processing devices, computer program products, and other devices.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions and/or embodiments discussed herein may be performed in a different order and/or concurrently with each other. Furthermore, if desired, one or more of the above-described functions and/or embodiments may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method comprising:
receiving a registration message from a local device of a local network via an Internet connection;
determining a public Internet identifier of the local network based on the Internet connection;
receiving a user login to an account, wherein the user login originates via the public Internet identifier of the local network; and
binding the local device to the account based on the user login originating from the public Internet identifier of the local network.

2. The method of claim 1, wherein the local device comprises a home device, and the local network comprises a home network.

3. The method of claim 1, further comprising facilitating configuration of the local device via an Internet service associated with the user account.

4. The method of claim 3, wherein facilitating configuration of the local device via the Internet service comprises embedding user interface controls for configuring the local device in a Web page associated with the user account.

5. The method of claim 1, further comprising:
receiving data from the local device; and
adding the data of the local device to the user account.

6. The method of claim 5, further comprising facilitating Internet access to the data of the local device in accordance with permissions of the user account.

7. The method of claim 1, wherein registration message comprises a unique ID associated with the local device.

8. The method of claim 1, further comprising:
in response to receiving the user login, sending a token to a user device from which the login was received, wherein the token is targeted for sending from the user device to the local device via the local network; and
receiving the token from the local device, and wherein binding the local device to the account is further based on receiving the token.

9. An apparatus comprising:
a processor configured with instructions that cause the apparatus to,
receive a registration message from a local device of a local network via an Internet connection;
determine a public Internet identifier of the local network based on the Internet connection;
receive a user login to an account, wherein the user login originates via the public Internet identifier of the local network; and
bind the local device to the account based on the user login originating from the public Internet identifier of the local network.

10. The apparatus of claim 9, wherein the instructions further cause the processor to facilitate configuration of the local device via an Internet service associated with the user account.

11. The apparatus of claim 10, wherein facilitating configuration of the local device via the Internet service comprises embedding user interface controls for configuring the local device in a Web page associated with the user account.

12. The apparatus of claim 9, wherein the instructions further cause the processor to:
receive data from the local device; and
add the data of the local device to the user account.

13. The apparatus of claim 12, wherein the instructions further cause the processor to facilitate Internet access to the data of the local device in accordance with permissions of the user account.

14. The apparatus of claim 9, wherein the instructions further cause the processor to:
in response to receiving the user login, send a token to a user device from which the login was received, wherein the token is targeted for sending from the user device to the local device via the local network; and
receive the token from the local device, and wherein binding the local device to the account is further based on receiving the token.

15. A computer-readable storage medium encoded with instructions that, when executed by an apparatus, perform:
receiving a registration message from a local device of a local network via an Internet connection;
determining a public Internet identifier of the local network based on the Internet connection;
receiving a user login to an account via the public Internet identifier of the local network;
binding the local device to the account based on the user login.

16. The computer-readable storage medium of claim 15, wherein the instructions further cause the processor to facilitate configuration of the local device via an Internet service associated with the user account.

17. The computer-readable storage medium of claim 16, wherein facilitating configuration of the local device via the Internet service comprises embedding user interface controls for configuring the local device in a Web page associated with the user account.

18. The computer-readable storage medium of claim 15, wherein the instructions further cause the processor to:
receive data from the local device; and
add the data of the local device to the user account.

19. The computer-readable storage medium of claim 18, wherein the instructions further cause the processor to facilitate Internet access to the data of the local device in accordance with permissions of the user account.

20. The computer-readable storage medium of claim 15, wherein the instructions further cause the processor to:
in response to receiving the user login, send a token to a user device from which the login was received, wherein the token is targeted for sending from the user device to the local device via the local network; and
receive the token from the local device, and wherein binding the local device to the account is further based on receiving the token.

21. A method comprising:
facilitating a user login to an account of an Internet service via a local network;
receiving a token and a local address of a local device of the local network from the Internet service in response to the user login; and
sending the token to the local address of the local network to facilitate binding the local device to the account of the Internet service.

22. The method of claim 21, wherein binding the local device to the account comprises receiving data generated from the local device at the Internet service, the method further comprising facilitating access to the data via the account.

23. The method of claim 21, wherein binding the local device to the account comprises facilitating configuring the local device via the Internet service, the method further comprising configuring the local device via the account.

24. The method of claim 21, wherein the local device is bound to the account based on the user login originating from a public Internet identifier of the local network.

25. The method of claim 21, further comprising, in response to receiving the token and the local address of the local device from the Internet service, presenting a browser pop up originating from the Internet service indicating a search for the local device is in progress.

26. An apparatus comprising:
a processor configured with instructions that cause the apparatus to,
facilitate a user login to an account of an Internet service via a local network;
receive a token and a local address of a local device of the local network from the Internet service in response to the user login; and
send the token to the local address of the local network to facilitate binding the local device to the account.

27. The apparatus of claim 26, wherein binding the local device to the account comprises receiving data generated from the local device at the Internet service, and wherein the instructions further cause the processor to facilitate access to the data of the local device via the account.

28. The apparatus of claim 26, wherein binding the local device to the account comprises facilitating configuring the local device via the Internet service, and wherein the instructions further cause the processor to configure the local device via the account.

29. The apparatus of claim 26, wherein the local device is bound to the account based on the user login originating from a public Internet identifier of the local network.

30. The apparatus of claim 26, wherein the instructions further cause the processor to, in response to receiving the token and the local address of the local device from the Internet service, present a browser pop up originating from the Internet service indicating a search for the local device is in progress.

31. A computer-readable storage medium encoded with instructions that, when executed by an apparatus, perform:
facilitating a user login to an account of an Internet service via a local network;
receiving a token and a local address of a local device of the local network from the Internet service in response to the user login; and
sending the token to the local address of the local network to facilitate binding the local device to the account.

32. The computer-readable storage medium of claim 31, wherein binding the local device to the account comprises receiving data generated from the local device at the Internet service, and wherein the instructions further cause the processor to configure facilitate access to the data of the local device via the account.

33. The computer-readable storage medium of claim 31, wherein binding the local device to the account comprises facilitating configuring the local device via the Internet service, and wherein the instructions further cause the processor to configure the local device via the account.

34. The computer-readable storage medium of claim 31, wherein the local device is bound to the account based on the user login originating from a public Internet identifier of the local network.

35. The computer-readable storage medium of claim 31, wherein the instructions further cause the processor to, in response to receiving the token and the local address of the local device from the Internet service, present a browser pop up originating from the Internet service indicating a search for the local device is in progress.
